(19) United States
(12) Patent Application Publication
(10) Pub. No.: US 2014/0108189 A1
(43) Pub. Date: Apr. 17, 2014

(54) Real-Time Cross-Selling Proposal Calculation

(71) Applicants: Rolf Schumann, Bad Schoenborn (DE); Arnulf Schüler, Heidelberg (DE); Lan Zhang, Wiesloch (DE); Sonja Zscherpel, Forst (DE); Thomas Maag, Reilingen (DE); Jens Tewes, Karlsruhe (DE)

(72) Inventors: Rolf Schumann, Bad Schoenborn (DE); Arnulf Schüler, Heidelberg (DE); Lan Zhang, Wiesloch (DE); Sonja Zscherpel, Forst (DE); Thomas Maag, Reilingen (DE); Jens Tewes, Karlsruhe (DE)

(21) Appl. No.: 13/650,053

(22) Filed: Oct. 11, 2012

(51) Int. Cl. G06Q 30/00

(52) U.S. Cl. 705/26.7

(57) ABSTRACT

A method for generating cross-selling product recommendations is provided. The method includes determining one or more base products purchased by a selected customer based on billing data, finding other customers who purchased the base products, determining one or more additional products which have been purchased by the other customers, sorting the additional products, and providing predictive data including information relating to the additional products to be recommended to the selected customer. Related apparatus, systems, techniques and articles are also described.

### TECHNICAL FIELD

This disclosure relates generally to generating one or more sales recommendations, and more particularly to generating one or more real-time cross-selling product recommendations for a customer.

### BACKGROUND

A company may have a large amount of sales data including, for example, customer purchase histories available to its sales force. Mining this data to generate predictive cross-selling product recommendations (e.g. a customer who purchased product A may also be interested in purchasing product B) can provide tremendous value to the salesforce by recommending those products to the customers, and potentially increasing sales and revenue. However, the amount of sales data is typically enormous, and even a relatively simple algorithm for generating a cross-selling product recommendation can require an enormous amount of calculations, which can be difficult (e.g. even impossible) to implement on some of the existing database systems. Furthermore, providing cross-selling product recommendations in real-time involve additional complexities and challenges, which cannot be met by some of the existing database systems.

Thus, there is a need to provide methods and systems for generating one or more predictive real-time cross-selling product recommendations/proposals for a customer and providing relevant information on the product recommendations/proposals.

### SUMMARY

In some implementations, the current subject matter relates to a computer-implemented method. The method can include determining one or more base products purchased by a selected customer based on billing data stored in a database; finding, in the database, one or more other customers who purchased the one or more base products; determining one or more additional products which have been purchased by the one or more other customers; sorting the one or more additional products by revenue and selecting one or more top additional products based on revenue; and providing predictive data including information relating to the one or more top additional products to be recommended to the selected customer; wherein at least one of the above is a set-oriented process performed on at least one processor.

In some implementations, the current subject matter further includes one or more of the following option features: determining a revenue ratio between the revenue of each one or more base products and each one or more top additional products; determining a buying probability of each one or more top additional products; determining an expected revenue for each one or more top additional products; and determining an expected margin for each one or more top additional products. In some implementations, the predictive data is provided in real-time based on real-time billing data. In some implementations, the database utilizes in-memory technology.

Non-transitory Computer program products are provided that store executable instructions which, when executed by at least one data processor to perform operations herein. Similarly, computer systems are also described that may include a processor and a memory coupled to the processor. The memory may temporarily or permanently store one or more programs that cause the processor to perform one or more of the operations described herein. In addition, operations specified by methods can be implemented by one or more data processors either within a single computing system or distributed among two or more computing systems.

The subject matter described herein provides many advantages. For example, by generating and providing one or more predictive real-time cross-selling product recommendations/proposals of a customer and providing relevant information on the product recommendations/proposals, a salesman may be able to sell additional products to the customer. Furthermore, the customer may benefit from the cross-selling product recommendations/proposals as well by being offered products which the customer may have a need for but have not purchased.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system including a data storage application;

FIG. 2 is a diagram illustrating details of the system of FIG. 1;

FIG. 3 is a process flow diagram illustrating an exemplary process according to implementations of the current subject matter;

FIGS. 4 and 5 illustrate an exemplary system and method, according to some implementations of the current subject matter.

### DETAILED DESCRIPTION

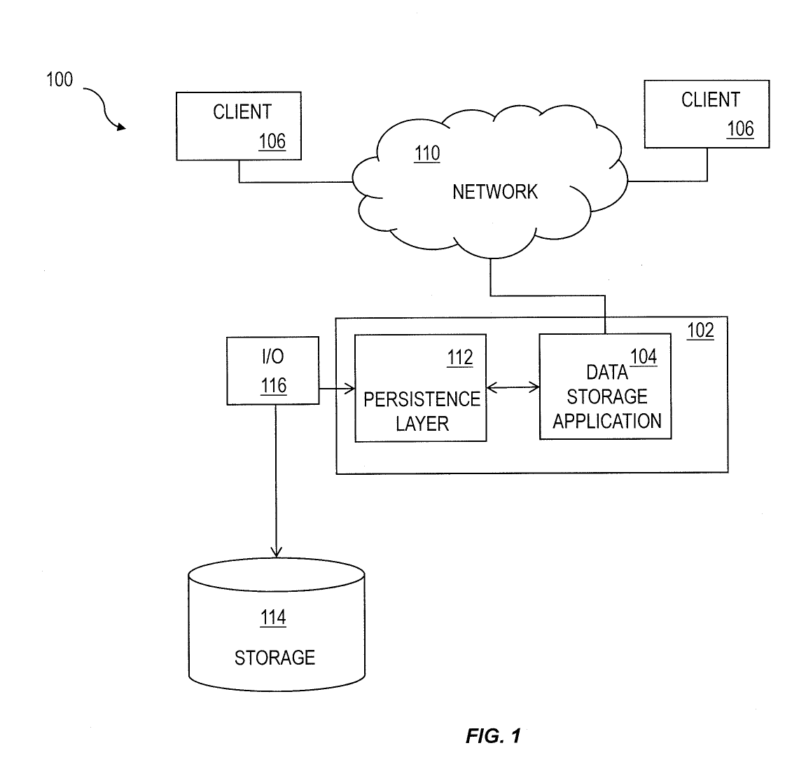

FIG. 1 shows an example of a system 100 in which a computing system 102, which can include one or more programmable processors that can be collocated, linked over one or more networks, etc., executes one or more modules, software components, or the like of a data storage application 104. The data storage application 104 can include one or more of a database, an enterprise resource program, a distributed storage system (e.g. NetApp Filer available from NetApp of Sunnyvale, Calif.), or the like.

The one or more modules, software components, or the like can be accessible to local users of the computing system 102 as well as to remote users accessing the computing system 102 from one or more client machines 106 over a network connection 110. One or more user interface screens produced by the one or more first modules can be displayed to a user, either via a local display or via a display associated with one of the client machines 106. Data units of the data storage application 104 can be transiently stored in a persistence layer 112 (e.g. a page buffer or other type of temporary persistency layer), which can write the data, in the form of storage pages, to one or more storages 114, for example via an input/output component 116. The one or more storages 114 can include one or more physical storage media or devices (e.g. hard disk drives, persistent flash memory, random access memory, optical media, magnetic media, and the like) configured for writing data for longer term storage. It should be noted that the storage 114 and the input/output component 116 can be included in the computing system 102 despite their being shown as external to the computing system 102 in FIG. 1.

Data retained at the longer term storage 114 can be organized in pages, each of which has allocated to it a defined amount of storage space. In some implementations, the amount of storage space allocated to each page can be constant and fixed. However, other implementations in which the amount of storage space allocated to each page can vary are also within the scope of the current subject matter.

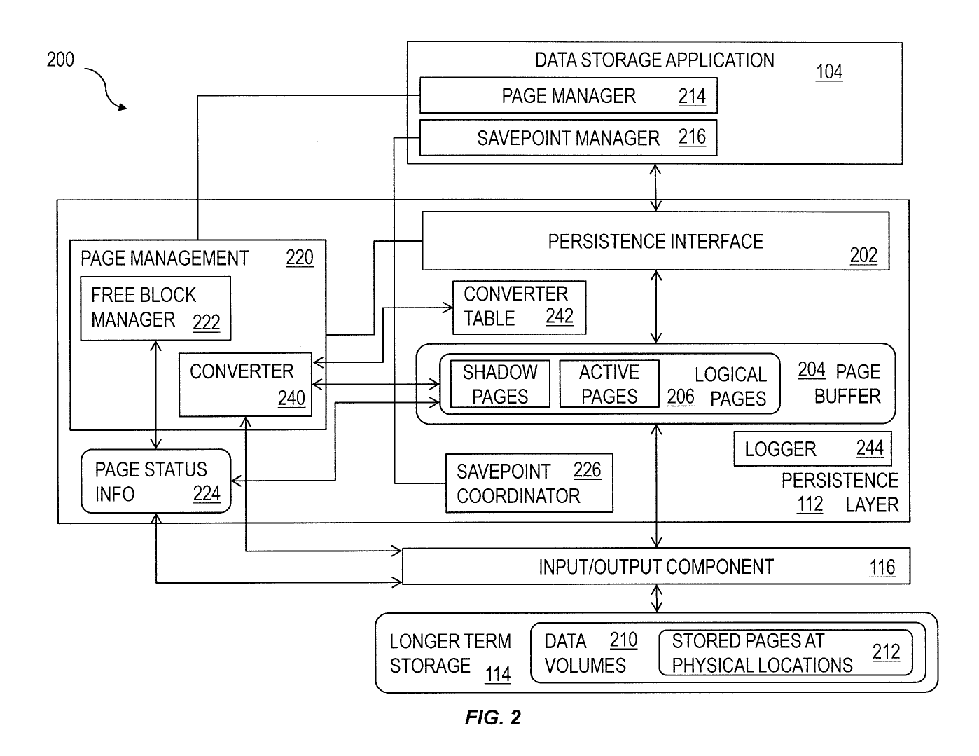

FIG. 2 shows software architecture 200 consistent with one or more features of the current subject matter. A data storage application 104, which can be implemented in one or more of hardware and software, can include one or more of a database application, a network-attached storage system, or the like. According to at least some implementations of the current subject matter, such a data storage application 104 can include or otherwise interface with a persistence layer 112 or other type of memory buffer, for example via a persistence interface 202. A page buffer 204 within the persistence layer 112 can store one or more logical pages 206, and optionally can include shadow pages, active pages, and the like. The logical pages 206 retained in the persistence layer 112 can be written to a storage (e.g. a longer term storage, etc.) 114 via an input/output component 116, which can be a software module, a sub-system implemented in one or more of software and hardware, or the like. The storage 114 can include one or more data volumes 210 where stored pages 212 are allocated at physical memory blocks.

In some implementations, the data storage application 104 can include or be otherwise in communication with a page manager 214 and/or a savepoint manager 216. The page manager 214 can communicate with a page management module 220 at the persistence layer 112 that can include a free block manager 222 that monitors page status information 224, for example the status of physical pages within the storage 114 and logical pages in the persistence layer 112 (and optionally in the page buffer 204). The savepoint manager 216 can communicate with a savepoint coordinator 226 at the persistence layer 112 to handle savepoints, which are used to create a consistent persistent state of the database for restart after a possible crash.

In some implementations of a data storage application 104, the page management module of the persistence layer 112 can implement a shadow paging. The free block manager 222 within the page management module 220 can maintain the status of physical pages. The page buffer 204 can included a fixed page status buffer that operates as discussed herein. A converter component 240, which can be part of or in communication with the page management module 220, can be responsible for mapping between logical and physical pages written to the storage 114. The converter 240 can maintain the current mapping of logical pages to the corresponding physical pages in a converter table 242. The converter 240 can maintain a current mapping of logical pages 206 to the corresponding physical pages in one or more converter tables 242. When a logical page 206 is read from storage 114, the storage page to be loaded can be looked up from the one or more converter tables 242 using the converter 240. When a logical page is written to storage 114 the first time after a savepoint, a new free physical page is assigned to the logical page. The free block manager 222 marks the new physical page as “used” and the new mapping is stored in the one or more converter tables 242.

The persistence layer 112 can ensure that changes made in the data storage application 104 are durable and that the data storage application 104 can be restored to a most recent committed state after a restart. Writing data to the storage 114 need not be synchronized with the end of the writing transaction. As such, uncommitted changes can be written to disk and committed changes may not yet be written to disk when a writing transaction is finished. After a system crash, changes made by transactions that were not finished can be rolled back. Changes occurring by already committed transactions should not be lost in this process. A logger component 244 can also be included to store the changes made to the data of the data storage application in a linear log. The logger component 244 can be used during recovery to replay operations since a last savepoint to ensure that all operations are applied to the data and that transactions with a logged “commit” record are committed before rolling back still-open transactions at the end of a recovery process.

With some data storage applications, writing data to a disk is not necessarily synchronized with the end of the writing transaction. Situations can occur in which uncommitted changes are written to disk and while, at the same time, committed changes are not yet written to disk when the writing transaction is finished. After a system crash, changes made by transactions that were not finished must be rolled back and changes by committed transaction must not be lost.

To ensure that committed changes are not lost, redo log information can be written by the logger component 244 whenever a change is made. This information can be written to disk at latest when the transaction ends. The log entries can be persisted in separate log volumes while normal data is written to data volumes. With a redo log, committed changes can be restored even if the corresponding data pages were not written to disk. For undoing uncommitted changes, the persistence layer 112 can use a combination of undo log entries (from one or more logs) and shadow paging.

The persistence interface 202 can handle read and write requests of stores (e.g., in-memory stores, etc.). The persistence interface 202 can also provide write methods for writing data both with logging and without logging. If the logged write operations are used, the persistence interface 202 invokes the logger 244. In addition, the logger 244 provides an interface that allows stores (e.g., in-memory stores, etc.) to directly add log entries into a log queue. The logger interface also provides methods to request that log entries in the in-memory log queue are flushed to disk.

Log entries contain a log sequence number, the type of the log entry and the identifier of the transaction. Depending on the operation type additional information is logged by the logger 244. For an entry of type “update”, for example, this would be the identification of the affected record and the after image of the modified data.

When the data application 104 is restarted, the log entries need to be processed. To speed up this process the redo log is not always processed from the beginning. Instead, as stated above, savepoints can be periodically performed that write all changes to disk that were made (e.g., in memory, etc.) since the last savepoint. When starting up the system, only the logs created after the last savepoint need to be processed. After the next backup operation the old log entries before the savepoint position can be removed.

When the logger 244 is invoked for writing log entries, it does not immediately write to disk. Instead it can put the log entries into a log queue in memory. The entries in the log queue can be written to disk at the latest when the corresponding transaction is finished (committed or aborted). To guarantee that the committed changes are not lost, the commit operation is not successfully finished before the corresponding log entries are flushed to disk. Writing log queue entries to disk can also be triggered by other events, for example when log queue pages are full or when a savepoint is performed.

With the current subject matter, the logger 244 can write a database log (or simply referred to herein as a “log”) sequentially into a memory buffer in natural order (e.g., sequential order, etc.). If several physical hard disks/storage devices are used to store log data, several log partitions can be defined. Thereafter, the logger 244 (which as stated above acts to generate and organize log data) can load-balance writing to log buffers over all available log partitions. In some cases, the load-balancing is according to a round-robin distributions scheme in which various writing operations are directed to log buffers in a sequential and continuous manner. With this arrangement, log buffers written to a single log segment of a particular partition of a multi-partition log are not consecutive. However, the log buffers can be reordered from log segments of all partitions during recovery to the proper order.

As stated above, the data storage application 104 can use shadow paging so that the savepoint manager 216 can write a transactionally-consistent savepoint. With such an arrangement, a data backup comprises a copy of all data pages contained in a particular savepoint, which was done as the first step of the data backup process. The current subject matter can be also applied to other types of data page storage.

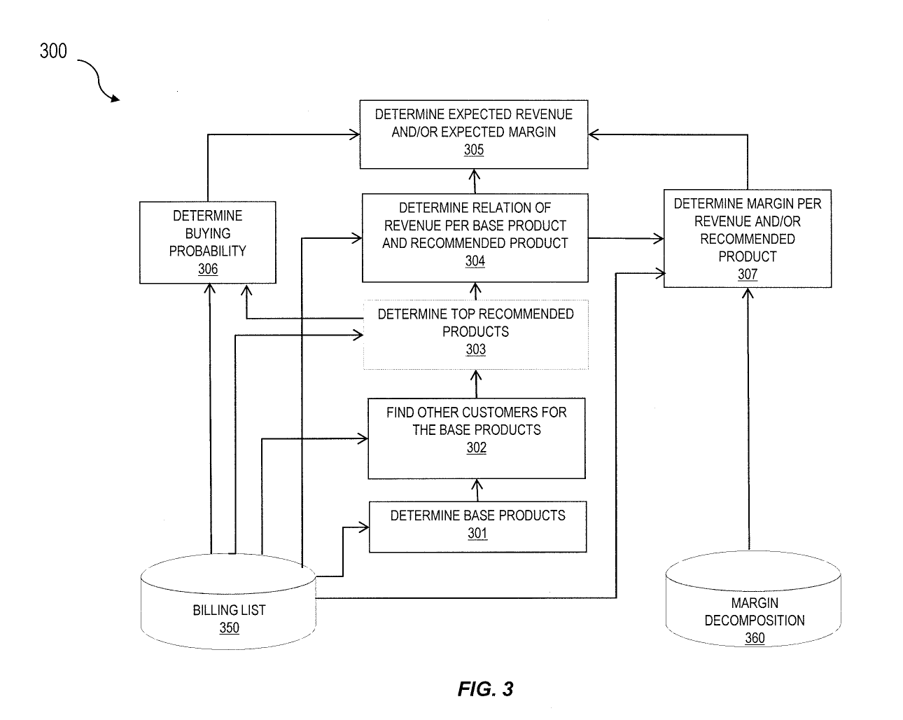

FIG. 3 shows a process flow 300 for generating one or more cross-selling product recommendations consistent with one or more features of the current subject matter. This process can be used, for example, to generate a report of one or more cross-selling product recommendations/proposals for a selected Customer. At 301, one or more top products (“Base Products”) purchased by the selected Customer is determined based on the Customer's buying history (e.g. a calculation view containing Billing List information). In some implementations, the top products are determined and/or ranked based on revenue. As an example, the top five Base Products for the selected Customer are determined and/or ranked. At 302, the system finds which other customer(s) also purchased those Base Products. The system then analyzes the buying histories of those other customers and determines, at 303, one or more products (“recommended products”) which were purchased by those other customers, but which have not been purchased by the selected Customer. In some implementations, the revenues of the recommended products are calculated, and/or ranked to determine the top recommended products that have generated the most revenues. In some implementations, this can be achieved by aggregating the total revenue of the particular recommended product across all other customers sharing one or more of the base products bought by the selected customer, thus taking into account product affinities across the whole basket of base products. In some implementations, each base product can be treated independently by aggregating the total revenue of particular recommended products only for those customers having bought the specific base product, thus neglecting potential product affinities across the whole basket of base products (e.g. reducing or eliminating unwanted noise). In some implementations, the option is selected based on the business context.

As an example, the top five recommended products are determined and/or ranked. At 304, the system determines a spending relationship (e.g. a ratio) between the revenue of each Base Product and each recommended Product. In other words, the system calculates how much those other customers have spent on the recommended products in relation to the Base Products that the selected customer has in its buying history. Using the spending relationship(s), the system determines (e.g. calculates), at 305, the expected revenues for the recommended products for the selected customer. For example, if the other customers spent on average twice as much on product A as they did on product B, then the expected revenue for the selected customer would be twice as much for product A as for product B. The system may also determine, at 306, a buying probability of each recommended product. In some implementations, the buying probability of product A is the percentage of the customers who bought both products A and B out of the customers who bought product B only. For example, 75% of the customers who bought B also bought A. Hence, it can be determined that cross-selling of product A to the selected Customer has a buying probability of 75%. Using margin data (e.g. a calculation view containing Margin Decomposition information), the system can determine the expected margin (at 305) by analyzing the margin those other customers achieved on average for the recommended products (307), and applying that margin to the selected Customer and determining the expected revenue of each recommended product for cross-selling. In some implementations, the system generates a report of the top recommended cross-selling products based on the top expected revenue and/or expected margin.

In some implementations, one or more of 301-307 are performed as set-oriented processes.

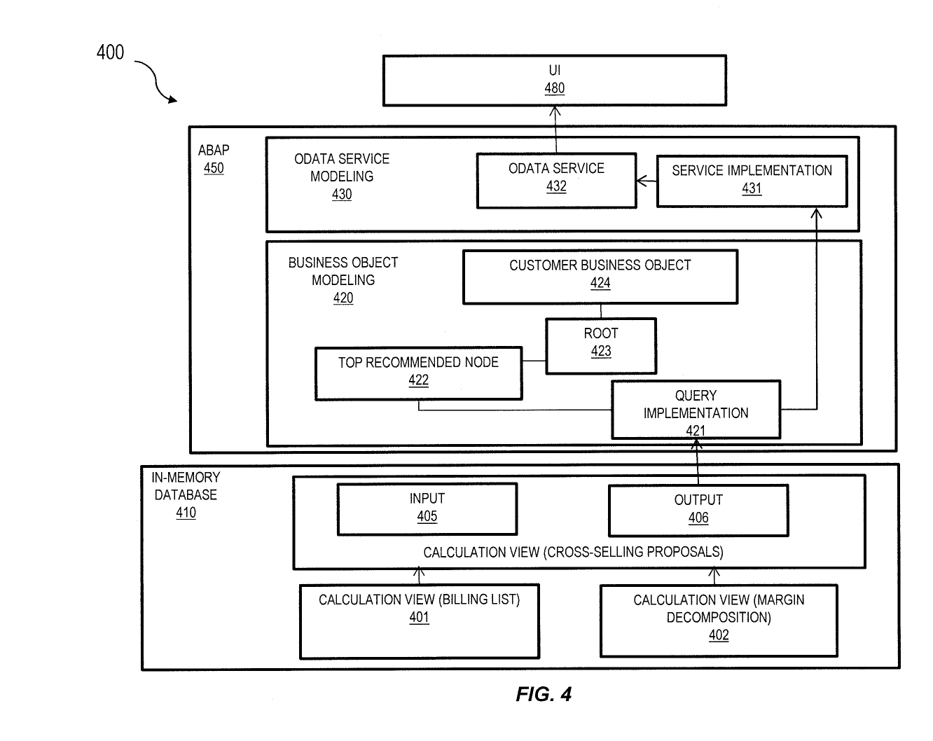

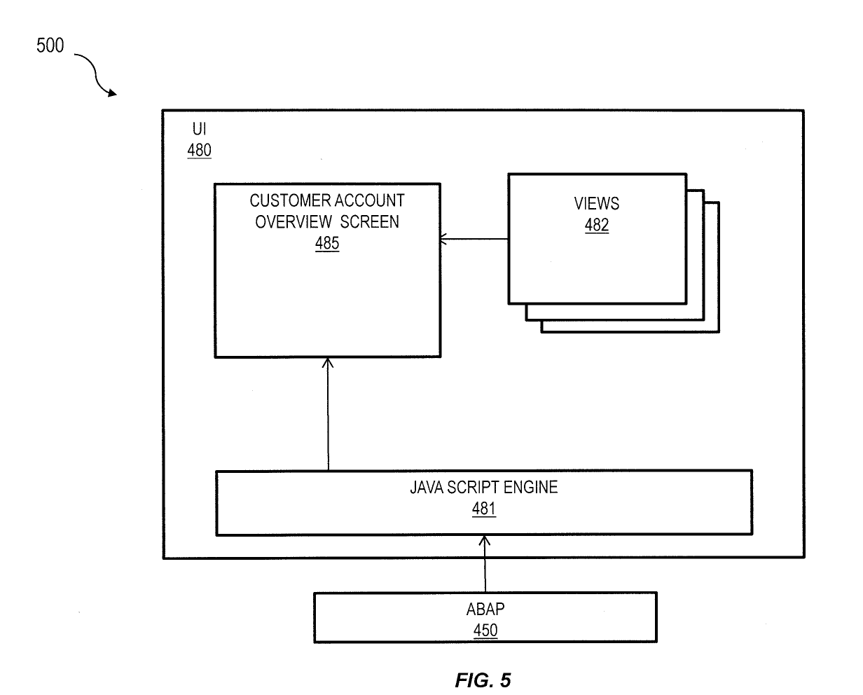

In some implementations, the system is implemented in an analytics database using in-memory technology (e.g. HANA DB from SAP AG, Walldorf Germany). This allows the system to go through the usually massive amounts of data in the relevant database (e.g. billing) to arrive at a meaningful analysis for recommending top cross-selling products. This also allows real-time data to be used to generate real-time cross-selling product recommendations. FIGS. 4 and 5 show an exemplary implementation of software architecture consistent with one or more features of the current subject matter in an analytics database using in-memory technology. As shown, in-memory database 410 includes a calculation view 401 containing Billing List information (e.g. billing histories) and a calculation view 402 containing Margin Decomposition (e.g. margin information). The data from these two calculation views 401 and 402 are used as inputs 405 for the calculation view containing cross-selling proposals (e.g. reports containing recommended cross-selling products) to generate an output 406 for Query Implementation 421 of Business Object Modeling module 420 of Advanced Business Application Programming (ABAP) 450. Query Implementation 421 is associated with a Top Recommendation Node 422, which is associated with ROOT 423, which in turn is associated with a Customer Business Object 424 in the Business Object Modeling module 420. Query Implementation 421 is configured to generate an output for Service Implementation 431, which in turn generates an output to ODATA Service 432. Service Implementation 431 and ODATA Service 432 are part of ODATA Service Modeling module 430. As shown in FIG. 5, ODATA Service 432 generates an output to Java Script Engine 481 of User Interface 480, which renders one or more cross-selling proposals generated by the system, for example, on Customer Account Overview Screen 485 to be viewed by a user (e.g. a salesman). User Interface 480 may be configured to provide a number of views 482 from which the user may navigate to the Customer Account Overview Screen 485. The Customer Account Overview Screen 485 may include one or more data (e.g. including all) including, for example, information of the selected Customer (e.g. name, contact(s), address, budget, etc.), one or more top Base Products (e.g. top products purchased by the Customer based on revenue), one or more top recommended cross-selling products, buying probability of each recommended product, expected revenue of each recommended product, and expected margin of each recommended product. In some implementations, one or more data may be represented graphically on the Customer Account Overview Screen 485 as, for example, bar graphs, pie charts, etc.

In some implementations, a transactional User Interface hands over the ID of the selected customer to a query assigned to a business object node. The query runs against an in-memory database. One or more set-oriented processes/calculations (e.g. consistent with the method shown in FIG. 3) may be performed to fetch predictive data in real-time. The result can be displayed, for example, on a fact sheet of the selected customer. In some implementations, the predictive data is stored in a database.

Aspects of the subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A computer-implemented method, comprising:
determining one or more base products purchased by a selected customer based on billing data stored in a database;
finding, in the database, one or more other customers who purchased the one or more base products;
determining one or more additional products which have been purchased by the one or more other customers;
sorting the one or more additional products by revenue and selecting one or more top additional products based on revenue;
providing predictive data comprising information relating to the one or more top additional products to be recommended to the selected customer;
wherein at least one of the above is a set-oriented process performed on at least one processor.

2. The computer-implemented method according to claim 1, further comprising determining a revenue ratio between the revenue of each one or more base products and each one or more top additional products.

3. The computer-implemented method according to claim 1, wherein the predictive data is provided in real-time based on real-time billing data.

4. The computer-implemented method according to claim 1, further comprising determining a buying probability of each one or more top additional products.

5. The computer-implemented method according to claim 1, further comprising determining an expected revenue for each one or more top additional products.

6. The computer-implemented method according to claim 1, further comprising determining an expected margin for each one or more top additional products.

7. The computer-implemented method according to claim 1, wherein the database utilizes in-memory technology.

8. A computer program product comprising a non-transitory machine-readable medium storing instructions that, when executed by at least one programmable processor, cause the at least one programmable processor to perform operations comprising:
determining one or more base products purchased by a selected customer based on billing data stored in a database;
finding, in the database, one or more other customers who purchased the one or more base products;
determining one or more additional products which have been purchased by the one or more other customers;
sorting the one or more additional products by revenue and selecting one or more top additional products based on revenue; and
providing predictive data comprising information relating to the one or more top additional products to be recommended to the selected customer.

9. The computer program product according to claim 8, further comprising determining a revenue ratio between the revenue of each one or more base products and each one or more top additional products.

10. The computer program product according to claim 8, wherein the predictive data is provided in real-time based on real-time billing data.

11. The computer program product according to claim 8, further comprising determining a buying probability of each one or more top additional products.

12. The computer program product according to claim 8, further comprising determining an expected revenue for each one or more top additional products.

13. The computer program product according to claim 8, further comprising determining an expected margin for each one or more top additional products.

14. The computer program product according to claim 8, wherein the database utilizes in-memory technology.

15. A system comprising:
at least one programmable processor; and
a non-transitory machine-readable medium storing instructions that, when executed by the at least one programmable processor, cause the at least one programmable processor to perform operations comprising:
determining one or more base products purchased by a selected customer based on billing data stored in a database;
finding, in the database, one or more other customers who purchased the one or more base products;
determining one or more additional products which have been purchased by the one or more other customers;
sorting the one or more additional products by revenue and selecting one or more top additional products based on revenue; and
providing predictive data comprising information relating to the one or more top additional products to be recommended to the selected customer.

16. The system according to claim 15, wherein the operations further comprises determining a revenue ratio between the revenue of each one or more base products and each one or more top additional products.

17. The system according to claim 15, wherein the predictive data is provided in real-time based on real-time billing data.

18. The system according to claim 15, wherein the operations further comprises determining a buying probability of each one or more top additional products.

19. The system according to claim 15, wherein the operations further comprises determining an expected revenue for each one or more top additional products.

20. The system according to claim 15, wherein the operations further comprises determining an expected margin for each one or more top additional products.
